(19) United States
(12) Patent Application Publication
(10) Pub. No.: US 2002/0110739 A1
(43) Pub. Date: Aug. 15, 2002

(54) Non-flammable electrolytes

(76) Inventors: Alan B. McEwen, Melrose, MA (US); Victor R. Koch, Lincoln, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 09/866,529

(22) Filed: May 25, 2001

Related U.S. Application Data
(60) Provisional application No. 60/207,613, filed on May 26, 2000.

(51) Int. Cl. H01M 10/40

(52) U.S. Cl. 429/324; 429/338; 429/342; 429/329; 429/303; 29/623.1; 29/623.2

(57) ABSTRACT

Improved electrolytes for application in electrical storage devices, such as batteries and capacitors, electrochromic display and other applications requiring tonically conductive medium are disclosed. The electrolytes of the invention contain organic cation salts, also called ionic liquids or molten salts. These improved electrolytes have useful characteristics such as high thermal stability and reduced flammability.

### CROSS REFERENCE TO RELATED APPLICATIONS

This application claims priority from U.S. provisional patent application Serial No. 60/207,613 filed May 26, 2000, the whole of which is hereby incorporated by reference herein.

### STATEMENT REGARDING FEDERALLY SPONSORED RESEARCH OR DEVELOPMENT

N/A

### BACKGROUND OF THE INVENTION

The present invention relates to electrolytes useful in electrochemical systems requiring thermal stability and non-flammability.

Over the past 20 years, rapid advances in consumer electronics have driven concurrent growth in the high energy density rechargeable battery market. In many applications, the battery is the component that limits the performance, size, and weight of the electronic device. The need for improved rechargeable battery chemistries has resulted in an active research and development effort by the battery industry to provide superior products for a wide range of applications including military/aerospace, consumer electronics, and electric vehicles.

Owing to their intrinsically high theoretical gravimetric and volumetric energy densities, rechargeable lithium-ion batteries hold great promise as power sources for the aforementioned applications. State-of-the-art lithium ion cells deliver almost 4 volts, have volumetric energy densities approaching 305 Wh/liter and possess a long shelf life at ambient temperature. Lithium-ion batteries are also called “rocking chair” batteries because the technology is based on the use of anodes and cathodes comprising lithium intercalation materials. Usually, a lithium transition metal oxide such as LiCoO₂ or LiCoₓNi₁₋ₓO₂ is used as a positive electrode or cathode and a carbonaceous material such as graphite is used for the negative electrode or anode.

Li-ion batteries have become a widely accepted commercial product today. The majority of the commercial Li-ion batteries are composed of prismatic or spiral wound cells of 1.5 to 2 Ah capacity and are used for powering portable consumer equipment such as cellular telephones and laptop computers.

There is a significant amount of current research and development activity to develop large Li-ion batteries for electric vehicle (EV) propulsion. EV batteries are built in sizes ranging from 20 to 40 KWh, significantly larger than the commercial batteries used in consumer electronics. Consequently, an unknown characteristic of Li-ion EV batteries is the safety hazard rooted in their enormous size. In particular, electrolyte flammability is of concern either due to electrolyte leakage from the battery or the battery being overcharged or abused. Therefore, the development of non-flammable electrolytes is extremely important for the successful fielding of Li-ion batteries for application in consumer electronic products and EV.

Early high energy density rechargeable batteries (and some still being developed today) used metallic lithium as the anode. The advantages of lithium intercalation-based anodes over metallic lithium, especially in cycle life and safety, far outweigh their disadvantages (see Winter et al. in Adv. Mater. 10, p.775 (1998). In replacing lithium metal with lithium-carbon anodes there is an obvious specific energy penalty because of the higher weight of the anode and the lower voltage of the battery due to the fact that lithium-carbon intercalation occurs at potentials higher than that of lithium deposition or dissolution on an inert electrode. This has provided motivation to develop high voltage cathodes such as the transition metal oxides of which the classical example is LiCoO₂.

The use of 4 volt cathodes, which routinely reach 4.3-4.4 V on charge, precludes the use of electrolytes based on ethereal solvents because ethers are oxidized between 3.7-4.0 V (vs. Li/Li⁺). Ethers are also highly flammable; for example, the flash point of diethyl ether is −40° C. Therefore, esters or alkyl carbonate solvents are typically used in Li-ion batteries. Another approach is the use of a solid polymer electrolyte. Polymers, which eliminate the need for volatile and flammable solvents, are considered to have safety advantages over liquid electrolytes. However, polymer electrolytes exhibit lower conductivities which must be compensated for by using thinner electrodes and separators and larger electrode areas, which compromise energy density. Thus, the development of non-flammable liquid electrolytes remains a highly desired goal.

The benchmark anode materials for lithium-ion cells is graphite, which intercalates lithium reversibly up to a stoichiometry of LiC₆, leading to a capacity of 372 mAh/gram. Another advantage of this carbon is the low, flat Li intercalation potential (close to that of Li/Li⁺). Graphite has a major disadvantage, however; in many polar aprotic solvents it is unstable at lithium intercalation potentials.

According to one school of thought, the main cause of instability of lithium-graphite anodes upon cycling is co-intercalation of solvent molecules along with the Li-ions into the graphite structure. This process, which may be accompanied by the reduction of the solvent, is detrimental to graphite stability and destroys its structure causing exfoliation of the graphite followed by physical and electrical disconnection of anode particles from the bulk. Another view is that there is no co-intercalation of solvent and the inability of graphite to intercalate Li is caused by the passivation of its surface by the deposition of electrolyte reduction products. Li intercalation is possible when the surface film is thin and has the characteristics of a solid electrolyte interphase (SEI). When graphite is immersed in non-aqueous electrolytes and is polarized to low potentials (vs. Li/Li⁺), solution species are reduced at potentials higher than that of the intercalation process and surface films are formed in analogy to the reduction processes at a lithium metal electrode. Once these surface films are fully developed and form compact passivating layers, which completely isolate the carbon active mass from the solution before it reaches intercalation potentials, the electrode is stabilized. In this situation, these surface films act as SEI or “molecular screens” which allow only Li-ion migration through them while simultaneously excluding solvent molecules. Therefore, using an appropriate electrolyte solution makes it possible to obtain extended cycle life with graphite electrodes. Since the Li transition metal oxide cathode is the only source of Li in conventional lithium-ion cells, any consumption of Li to produce the solid electrolyte interphase films leads to capacity loss. Thus, the amount of irreversible capacity loss which occurs on the carbon during the first intercalation of lithium must be minimized, and the appropriate electrolyte must be chosen in order to build a compact passivating layer with minimum loss of capacity.

Electrolytes that are nonflammable are needed to ensure the safety of lithium ion batteries. These electrolytes must be capable of being used with high potential lithium intercalation cathodes and anodes consisting of either lithium metal or lithium intercalation material (e.g., graphite). Any electrolytes used with lithium ion batteries should have good cycling characteristics for long battery life.

### BRIEF SUMMARY OF THE INVENTION

The invention is directed improved electrolytes for application in electrical storage devices, such as batteries and capacitors, electrochromic display and other applications requiring ionically conductive medium, that have reduced flammability compared to prior art devices. The electrolytes of the invention include an organic cation salt, sometimes called an ionic liquid (IL) or a molten salt. Batteries that use the electrolytes of the invention have improved performance and safety characteristics. The organic cation salts in the electrolytes of the invention are selected from the group of cyclic stabilized organic cations and quaternary ammonium and phosphonium cations combined with inorganic or organic anions. Gel polymer electrolytes using organic cation salts and batteries using such electrolytes are also described.

### BRIEF DESCRIPTION OF THE DRAWINGS

Other features and advantages of the invention will be apparent from the following detailed description of the invention, taken in conjunction with the accompanying drawings in which:

FIG. 1 shows the molecular structures of representative organic cations useful in forming the organic cation salts used in this invention;

FIG. 2 shows the molecular structures of representative anions useful in forming the organic cation salts used in this invention where (I) is bis(trifluormethylsulfony)imide commonly referred to as “Imide or Im,” (II) is bis(perfluorethylsulfony)imide commonly referred to as “Beti,” (III) is trifluoromethanesulfonate commonly referred to as “Triflate or OTf,” (IV) is tris(trifluormethylsulfony)methide, commonly referred to as “Methide or Me,” (V) is tetrafluoroborate, (VI) is hexafluorophosphate, and (VII) is hexafluoroarsinate;

FIG. 3A shows the molecular structure of 1-ethyl-3-methyl-imidazolium (EMI);

FIG. 3B shows the molecular structure of 1,2-dimethyl-3 ethyl-imidazolium (DMEI);

FIG. 3C shows the molecular structure of 1,2-dimethyl-3 propyl-imidazolium (DMPI);

FIG. 3D shows the molecular structure of pentamethyl-imidazolium imide (M₅IIm);

FIG. 3E shows the molecular structure of tetraethyl ammonium imide (TEAIm or Et₄NIm);

FIG. 3F shows the molecular structure of 1,2-dimethyl pyrazolium hexafluorphosphate (DMPPF₆);

FIG. 4 shows a plot of the voltage (V) vs. capacity (milliamphere-hour per square centimeter (mAh/cm²)) for a graphite electrode using the electrolyte 1M LiPF₆ in EMIIm:DMC (9:1) and lithium metal as a counter electrode and lithium metal as the reference electrode. The lst, 6^{th}, and 10^{th} cycles are shown and compared to a standard flammable lithium electrolyte (S);

FIG. 5 shows a plot of the voltage (V) vs. capacity (mAh/cm²) for a graphite electrode using the electrolyte 1M LiPF₆ in EMIIm:EC:DMC (6:1:1) and lithium metal as a counter electrode and lithium metal as the reference electrode. The 1^{st}, 5^{th}, and 10^{th} cycles are shown and compared to a standard flammable lithium electrolyte (S);

FIG. 6 shows a plot of the capacity (mAh/cm2) vs. cycle number (#) for a graphite electrode in two electrolytes (♦) 1M LiPF₆ in EMIIm:DMC (9:1) and (∘) 1M LiPF₆ in EMIIm:EC:DMC (6:1:1);

FIG. 7 shows voltage vs. capacity for the first cycle of a graphite/LiCoO₂ lithium ion battery containing 1M LiPF₆ in EMIIm:EC:DMC (6:1:1);

FIG. 8 shows the cycling efficiency in percent (%) versus cycle number (#) for a graphite/LiCoO₂ lithium ion battery containing 1M LiPF₆ in EMIIm:EC:DMC (6:1:1);

FIG. 9 shows the first discharge from a lithium metal anode and LiCoO₂ cathode battery using the organic salt electrolyte 3M DMEIIm in PC. Discharge voltage (V) vs. time in hours is plotted;

FIG. 10 shows the capacity for the battery of FIG. 9 vs. cycle number;

FIG. 11 shows cycling results (capacity in mAh [charge (▴), discharge (▪)] vs. cycle number) for a lithium ion battery (graphite anode and cobalt oxide cathode) comparing organic salt electrolytes: (A) 0.5 M LiPF₆ and 1.5 M M₅IIm in PC:glyme (1:1 volume ratio); (B) 0.5 M LiPF₆ and 1.5 M M₅IIm in PC:diglyme (1:1); (C) 0.5 M LiPF₆ and 1.5 M M₅IIm in PC; (D) 0.5 M LiPF₆ and 1.5 M M₅IIm in PC:tetraglyme (1:1); and (E) 0.5 M LiPF₆ and 1.5 M M₅IIm in PC:triglyme (1:1);

FIG. 12 shows cycling results (capacity in mAh [charge (▴), discharge (▪)]vs. cycle number) for a lithium ion battery (graphite anode and cobalt oxide cathode) comparing organic salt electrolytes with differing lithium salt: (1) 0.5 M LiPF₆ and 2.5 M M₅IIm in PC:glyme (1:1); (2) 0.5 M LiBeti and 2.5 M M₅IIm in PC:glyme (1:1); (3) 0.5 M LiMethide and 2.5 M M₅IIm in PC:glyme (1:1); (4) 0.5 M LiImide and 2.5 M M₅IIm in PC:glyme (1:1);

FIG. 13 shows the charge (♦) and discharge (∘) capacity (mAh) vs. cycle number (#) for a graphite/LiCoO₂ battery using 0.5M LiPF₆ and 1.5M M₅IIm in EC as the electrolyte;

FIG. 14 shows the charge (▪) and discharge (∘) capacity (mAh) vs. cycle number (#) for a graphite/LiCoO₂ battery using 0.5M LiPF₆ and 1.5M TEAIm in EC as the electrolyte;

FIG. 15 shows the charge (▪) and discharge (∘) capacity (mAh) vs. cycle number (#) for a graphite/LiCoO₂ battery using 0.5M LiPF₆ and 1.5M M₅IMe in PC and glyme(1:1 volume ratio) as the electrolyte;

FIG. 16 shows the charge (▪) and discharge (∘) capacity (mAh) vs. cycle number (#) for a graphite/LiCoO₂ battery using 0.5M LiPF₆ and 1.5M M₅IBeti in PC and glyme (1:1 volume ratio) as the electrolyte;

FIG. 17 shows the voltage (V) vs. time (hrs) for the first five cycles of a graphite/LiCoO₂ battery using 0.5M LiPF₆ and 1.5M 1-heptyl-tetramethyl-imidazolium imide in PC and glyme (1:1 volume ratio) as the electrolyte;

FIG. 18 shows a plot of voltage (V) vs. time (hrs) for a Li/LiₓC coin cell containing a LiPF₆/M₅IIm:EC:PC:PVdF electrolyte at 25° C.;

FIG. 19 shows a plot of voltage (V) vs. time (hrs) for a Li/LiCoO₂ coin cell containing a LiPF₆/M₅IIm:EC:PC:PVdF electrolyte at 25° C. (a) and 37° C. (b);

FIG. 20 shows a plot of voltage (V) vs. time (hrs) for a LiₓC/LiCoO₂ coin cell containing a thermally polymerized LiPF₆/M₅IIm:EC:PC:TEGDA:MMA electrolyte at 25° C.;

FIG. 21 shows the charge (▪) and discharge (∘) capacity (mAh) vs. cycle number (#) for a LiₓC/LiCoO₂ coin cell containing a LiPF₆/M₅IIm:EC:PC:PVdF electrolyte at a 4.2V cutoff voltage;

FIG. 22 shows the charge (▪) and discharge (∘) capacity (mAh) vs. cycle number (#) for a Li/LiCoO₂ coin cell containing a LiPF₆/M₅IIm:EC:PC:PVdF electrolyte at a 4.2 V cutoff voltage (cycles 1-3)and then a 4.6 V cutoff voltage (cycles 4-10);

FIG. 23 shows a plot of voltage (V) vs. time (hrs) for a LiₓC/LiCoO₂ coin cell containing a thermally polymerized 0.65 M LiBeti & 0.75 M Et₄NIm in EC:PC:TEGDA:MMA (46:40:8:6 mass ratio) electrolyte at 25° C.;

FIG. 24 shows a TGA plot of mass (percent of total) vs. temperature comparing EC based liquid electrolytes containing (A) neat EC; (B) 0.5M LiPF₆; (C) 0.5M LiPF₆ & 1.5 M Et₄NIm; (D) 0.5M LiPF₆ & 1.5 M DMPPF₆; (E) 0.5M LiPF6 & 1.5 M EMIIm; (F) 0.5M LiPF₆ & 1.5 M M₅IBeti; and

FIG. 25 shows a TGA plot of mass (percent of total) vs. temperature comparing gel electrolytes (PC:EC:TEGDA:MMA) containing (A) 0.6M LiBeti & 0.75 M Et₄NIm; (B) 0.6M LiBeti & 0.75 M M₅IIm; (C) 0.6M LiPF₆ & 0.75 M Et₄NIm; (D) 0.6M LiPF₆ & 0.75 M M₅IIm; (E) 1M LiPF₆; and (F) 0.6M LiPF₆.

### DETAILED DESCRIPTION OF THE INVENTION

An electrolyte made according to the invention contains a salt additive comprising organic cations. This organic cation salt additive is sometimes referred to as an ionic liquid or molten salt. In addition to the organic salt, the electrolyte may contain one or more organic solvents and a metal salt appropriately chosen for the operation of e.g., a battery. The electrolyte with the organic salt additive has reduced flammability properties and reduced volatility that is of use in the design of safe batteries. Nonflammable, or reduced flammability, electrolytes are critically important for the next generation of safe power sources used in applications running the gamut from laptop computers to hybrid electric vehicles.

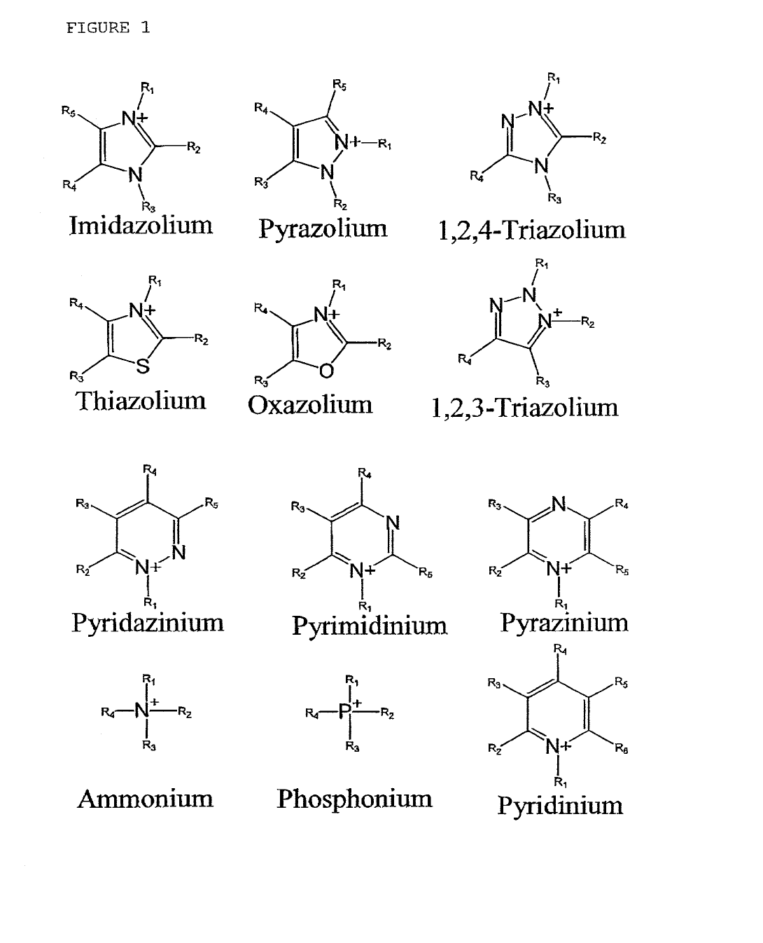

The organic cation salts comprise combinations of either delocalized heterocyclic cations or quaternary ammonium or phosphonium cations combined with anions. The organic cation has one of the structures depicted in FIG. 1, wherein R₁, R₂, R₃, R₄, R₅, and R₆ are either H; F; separate alkyl groups of from 1 to 15 carbon atoms, respectively; or two of said separate alkyl groups are joined together to constitute a unitary alkylene radical of from 2 to 6 carbon atoms forming a ring structure converging on N; or separate phenyl group, and wherein the alkyl groups, unitary alkylene radical or phenyl groups are optionally substituted.

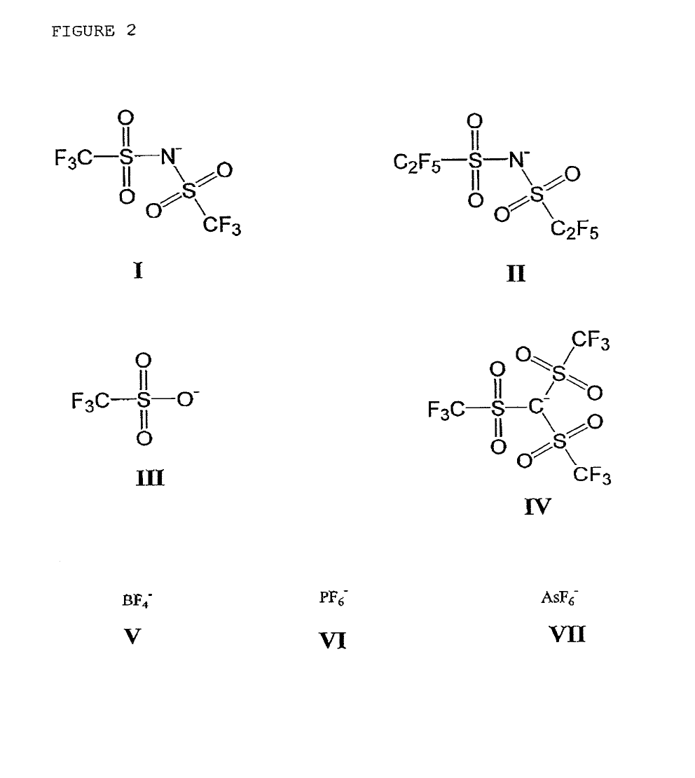

Various possible anion species may be used in forming the ionic liquid or organic cation salt additives used in the formulating of nonflammable electrolytes that are the object of this invention. Several examples are depicted in FIG. 2.

The synthesis of the ionic liquid/molten salt additives is accomplished via established methods. For example, see U.S. Pat. Nos. 5,827,602 and 5,077,414, the reports of Kuhn et al., in Z. Naturforsch., 46B, 1706 (1991), and Bonhote et al., in Inorg. Chem., 35, 1168 (1996). Additional examples of the synthesis of quaternary ammonium salts which are useful in practicing the invention disclosed herein, can be found in Electrochimica Acta, 45, 1271 (2000).

For battery applications, representative examples of salts containing a metal cation particularity alkali and alkaline earth metal, cations, are selected from a group consisting of Li⁺, Na⁺, K⁺, Ca⁺⁺, Mg⁺⁺, and Al⁺⁺⁺. The anions of these salts can be organic or inorganic. Specific examples of suitable anions include I⁻, Br⁻, SCN⁻, BF₄⁻, PF₆⁻, AsF₆⁻, CF₃SO₂⁻, (CF₃SO₂)₂N⁻, (CF₃CF₂SO₂)₂N⁻, and (CF₃SO₂)₃C⁻.

The organic solvent of the present invention is not particularly limited as long as it can solubilize the organic cation salt(s) and the metal salt(s). Either an individual solvent may be used alone, or a mixed solvent containing a plurality of solvents may be used. Examples of solvents used in the present invention are cyclic and acyclic, saturated or unsaturated organic carbonates such as ethylene carbonate (EC), propylene carbonate (PC), dimethyl carbonate (DMC), diethyl carbonate (DEC), ethyl methyl carbonate (EMC), ethyl propyl carbonate (EPC), propyl methyl carbonates (PMC)) (n- and iso-), butyl methyl carbonates (BMC n-, sec-, and iso-), and butylene carbonate (BC). Other solvents that may be used are gamma-butyrolactone (GBL), methyl acetate (MA), ethyl acetate (EA), methyl formate (MF), sulfolane, methylsulfolane, diethyl ether, methyl ethyl ether, tetrahydrofuran (THF), 2-methyltetrahydrofuran, 1,3-dioxolane, nitromethane, acetonitrile (AN), dimethylformamide (DMF), dimethylacetamide, dimethylsulfoxide (DMSO) and benzonitrile.

In further embodiments, electrolytes made according to the invention may also contain quantities of organic materials such as vinylene carbonate (VC), or alkyl phosphonates, or alkyl nitrites and derivatives. These materials, when added to the electrolyte in amounts ranging from approximately 0.05 to 5 weight percent, have been found to reduce the irreversible capacity on the first cycle of a lithium ion cell.

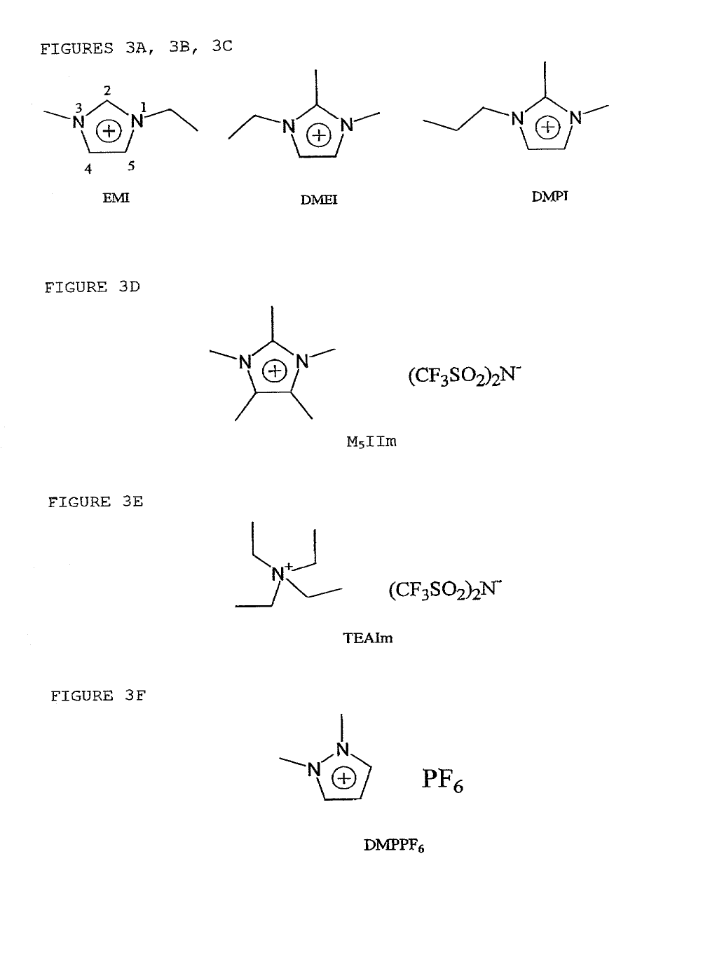

Various imidazolium cation structures can be used to form the organic cation salt. For example, 1,3 alkylation at the two nitrogen atoms with an ethyl and methyl group results in the 1-ethyl-3-methyl imidazolium (EMI) cation (FIG. 3A). Likewise 1,2,3 trialkylation can result in 1,2-dimethyl-3-ethyl imidazolium (DMEI—FIG. 3B) and 1,2-dimethyl-3-propyl imidazolium (DMPI—FIG. 3C) cation structures. These 1,2,3 trialkylated imidazolium structures have removed the slightly acidic hydrogen at the C(2) position and have increased reductive stability compared to the 1,3 dialkylated imidazolium cations. For lithium ion batteries we have found that we can get good cycling using these 1,3 dialkylated and 1,2,3 trialkylated imidazolium cation salts if we first form the SEI on the carbon negative electrode before introducing these organic cation containing electrolytes.

Improved cycling behavior is realized using the peralkylated imidazolium cation in combination with various anions to form the nonflammable electrolytes. An example of such a salt is the pentamethyl imidazolium organic cation shown in FIG. 3D as the bis(trifluoromethylsulfonyl) imide salt. By using an electrolyte made of 0.5 M lithium PF₆ and 1.5 M pentamethyl imidazolium imide in ethylene carbonate, we can get excellent in situ SEI formation and cycling. We also get similar good performance using tetraethyl ammonium (TEA) imide (FIG. 3E) or 1,2-dimethyl pyrazolium PF6 (FIG. 3F) as the organic cation salt in this formulation.

TABLE 1
Flash point data comparing carbonate solvents,
typical lithium electrolytes, and organic cation based
electrolytes.

| | Flash | | Flash |
|---|---|---|---|
| | Point | | Point |
| Solvent | (° C.) | Electrolyte | (° C.) |
| DMC | 18 | EMIIm | >180 |
| DEC | 31 | DMEIBETI | >180 |
| MPC | 36 | 0.5 M LiAsF₆/EMIIm | >180 |
| EMC | <25 | 0.5 M LiIm/EMIIm | >180 |
| i-PMC | <25 | 1.0 M LiPF₆/EMIIm | >180 |
| MOEMC | 79 | 0.5 M LiPF₆/EMIIm | >180 |
| EC | 150 | 0.5 M LiPF₆/EMIIm & Li₂CO₃ | >180 |
| PC | 123 | 0.5 M LiPF₆/DMC | <23 |
| TCEMC | 112 | 1 M LiPF₆/DMC | <23 |
| TFEMC | 36 | 1.0 M LiPF₆/EMIIm:DMC (3:1) | 55 |
| | | volume ratio | |

Solvents: dimethyl carbonate (DMC), diethyl carbonate (DEC), methyl propyl carbonate (MPC), ethyl methyl carbonate (EMC), iso-propyl methyl carbonate (i-PMC), methoxyethyl methyl carbonate (MOEMC), ethylene carbonate (EC), propylene carbonate (PC), trichloroethyl methyl carbonate (TCEMC), trifluoroethyl methyl carbonate (TFEMC).

The nonflammable electrolytes that are the object of this invention can be made into gelled electrolytes with the appropriate addition of additives to provide the desired gel properties. The addition of binders, such as PVDF, or cross-linking materials can transform the nonflammable liquid electrolytes into gel polymer electrolytes (GPE). We have found that we can use thermal and photo-initiated cross-linking to obtain free standing nonflammable GPEs that have use in electrochemical cells. These gel polymer electrolytes are more desirable for power source applications than are liquid electrolytes, as the gel polymer electrolytes of the invention offer a number of significant competitive advantages over their liquid electrolyte counterparts:

Mechanical flexibility, enabling novel power source geometries and form factors

Simplification of power source components leading to less expensive, more robust devices

Higher gravimetric and volumetric energy densities due to the use of light weight packaging materials

Improved safety, since no free-flowing organic solvents are present.

In addition to providing conductivities similar to those provided by liquid electrolytes, the gel polymer electrolytes (GPE) described in this invention embody all of the advantages noted above and also incorporate the highly desirable feature of nonflammability.

For battery applications, the non-flammable GPEs of the present invention contain at least the following: one organic cation salt or ionic liquid material, a salt containing a metal cation, an organic solvent, and either an acrylate polymer (as a result of thermochemical or photochemical polymerization) or one or more fluoropolymers such as poly(vinylidene)fluoride. For electrochemical capacitor applications, the salt containing a metal cation is omitted. In all cases, however, electrolyte non-flammability is conferred on the GPEs by the presence of ionic liquid materials.

In the case of a GPE comprising an acrylate polymer, the acrylate polymer used in this invention is made of methylmethyacrylate or a variation thereof with at least one monomer copolymerizable to the methylmethacrylate. In the present invention, the methylmethacrylate polymer is not limited to one kind, but may also be used in combination of two or more kinds of acrylate-based polymers.

The copolymerizable monomer in not limited to specific kinds as long as the resulting acrylate polymer does not phase separate from the ionic liquid material. Examples of copolymerizable monomers are styrene-containing monomers such as styrene itself, divinyl benzene, cyano-group-containing monomers such as methacrylonitrile, unsaturated carboxylic acids such as acrylic acid and their salts such as sodium acrylate, acid anhydrides such as maleic anhydride, esters such as methyl methacrylate, ethyl acrylate, propyl acrylate, tetra(ethylene glycol) diacrylate, hydroxyethyl methacrylate, vinyl halides such as vinyl chloride, vinyl fluoride, and vinyl bromide, vinylidene halide monomers such as vinylidene chloride, vinylidene fluoride, and vinylidene bromide, vinyl esters such as vinyl formate, vinyl acetate, vinyl group-containing acids compounds or their salts, anhydrides or derivatives, such as p-styrenesulfonic acid, methallylsulfonic acid, vinyl ethers such as methyl vinyl ether, dienes such as butadiene, isoprene and chloroprene.

In the case of a GPE comprising a poly(vinylidene)fluoride (PVdF), the present invention is not limited to a single fluoropolymer, but may also be used in combination of two or more kinds of fluoropolymers such as polyhexafluoropropylenes, polyperfluoroalkoxytrifluoroethylenes, polyvinylfluorides, polytetrafluoroethylenes, and mixtures thereof.

The organic solvent of the present invention is not particularly limited as long as it can solubilize the ionic liquid material(s), the monomer(s), and the metal salt(s). Either a solvent may be used alone or a mixed solvent containing a plurality of solvents may be used. Examples of solvents used in the present invention are cyclic and acyclic, saturated or unsaturated organic carbonates such as ethylene carbonate (EC), propylene carbonate (PC), dimethyl carbonate (DMC), diethyl carbonate (DEC), ethyl methyl carbonate (EMC), ethyl propyl catbonate (EPC), propyl methyl carbonates (PMC)) (n- and iso-), butyl methyl carbonates (BMC) (n-, sec-, and iso-), butylene carbonate(BC), and vinylidene carbonate (VC). Other solvents that may be used are gamma-butyrolactone (GBL), methyl acetate (MA), ethyl acetate (EA), methyl formate (MF), sulfolane, methylsulfolane, diethyl ether, methyl ethyl ether, tetrahydrofuran (THF), 2-methyltetrahydrofuran, 1,3-dioxolane, nitromethane, acetonitrile (AN), dimethylformamide (DMF), dimethylacetamide, dimethylsulfoxide (DMSO), and benzonitrile.

In a further embodiment, the GPE may also contain quantities of inorganic materials such as alumina (Al₂O₃) or silica (SiO₂). Finely divided alumina or silica particles, when added to the GPE in amounts ranging from approximately 0.5 to 5% by weight, have been found to improve the mechanical properties of the GPE and also serve to scavenge residual protic impurities such as water.

Three general methods regarding the production of non-flammable GPEs for lithium battery applications are as follows:

A thermal gelation technique where the ionic liquid, a lithium salt, and a fluoropolymer such as PVdF [poly(vinylidene fluoride)] are heated together at approximately 100° C. to yield a homogeneous melt that, when cast onto a Teflon or glass plate and cooled, forms a mechanically robust GPE.

A light initiated polymerization technique where a solution of the ionic liquid, a lithium salt, acrylate monomers such as tetra(ethylene glycol) diacrylate (TEGDA), methyl methyacrylate (MMA), and small quantities of either 2,2′-azobisisobutyronitrile (ABIN) or benzoyl peroxide (BP) used as a photoinitiator are irradiated under UV light to form a mechanically robust GPE.

A thermally initiated polymerization technique where a solution of the ionic liquid, a lithium salt, acrylate monomers such as TEGDA, MMA, and ABIN or BP are heated to approximately 60° C. to form a mechanically robust GPE.

The same three methods for the production of non-flammable GPEs for electrochemical capacitor applications are as above with the lithium salt omitted from the electrolyte formulation.

All of the GPEs were prepared in a dry, Ar-filled glove box in order to preclude exposure to water vapor. GPEs comprising organic solvents and prepared by the hot melt technique, UV initiated polymerization, or thermally initiated polymerization provided freestanding films with no evidence of phase separation between liquid and solid components.

For battery applications, GPEs that provided the best cycling results comprised quantities of a saturated or unsaturated cyclic or acyclic organic carbonate or lactone. Most of the GPEs comprised ethylene carbonate (EC) and propylene carbonate (PC), or from 2 to 3 volume percent of vinylidene carbonate used as an additive. Combinations of EC and gamma-butyrolactone (GBL) afforded results similar to the EC/PC solvent blends.

For convenience, the following organic cation abbreviations are used: “EMI” represents the 1-ethyl-3-methylimidazolium cation, “M₅I” represents the pentamethylimidazolium cation, “M₅P” represents the pentamethylpyrazinium cation, “DMP” represents the 1,2-dimethylpyrazolium cation, “BI” represents the n-butylpyridinium cation, and “Et₄N” or “TEA” represents the tetraethylammonium cation.

The GPEs of this invention were evaluated by the methods described below.

Flammability Test

Electrolyte flammability was determined by exposing the GPE directly to the flame of a butane torch after which the torch was removed. A flammable GPE is defined as one that was consumed by flame once ignited. A non-flammable GPE is defined as one that either failed to ignite, or self-extinguished upon removal of the torch.

Table 2 presents electrolyte formulations, ionic conductivities, and the flammability of a number of GPEs with and without ionic liquid materials. As can be seen, prior art electrolytes without organic cation salts are flammable. However, electrolytes according tot he invention including organic cation salts are non-flammable.

TABLE 2
Properties of various gel polymer electrolytes
with and without ionic liquid materials.

| | Conductivity | |
|---|---|---|
| Gel Polymer Electrolyte | mS/cm, 25° C. | Flammability |
| 0.65 M LiPF₆ & 0.75 M BIIm in | 5.2 | Non-flammable |
| EC:PC:TEGDA:MMA (46:40:8:6 mass ratio) | | |
| 0.65 M LiPF₆ & 0.75 M DMPPF₆ in | 6.1 | Non-flammable |
| EC:PC:TEGDA:MMA (46:40:8:6 mass ratio) | | |
| 0.65 M LiPF₆ & 0.75 M M₅IBeti in | 6.6 | Non-flammable |
| EC:PC:TEGDA:MMA (46:40:8:6 mass ratio) | | |
| 0.65 M LiPF₆ & 0.75 M Et₄NIm in | 2.9 | Non-flammable |
| EC:PC:TEGDA:MMA (46:40:8:6 mass ratio) | | |
| 0.65 M LiPF₆ & 0.75 M M₅PIm in | 2.4 | Non-flammable |
| EC:PC:TEGDA:MMA (46:40:8:6 mass ratio) | | |
| 0.65 M LiBeti & 0.75 M M₅IIm in | 4.2 | Non-flammable |
| EC:PC:TEGDA:MMA (46:40:8:6 mass ratio) | | |
| 0.65 M LiPF₆ & 0.75 M EMIIm in PVdF | 4.0 | Non-flammable |
| 0.65 M LiPF₆ & 0.75 M M₅IIm in EC:PC:PVdF | 5.1 | Non-flammable |
| (41:37:22 mass ratio) | | |
| 0.65 M LiPF₆ & 0.75 M M₅IIm in | 4.1 | Non-flammable |
| EC:PC:PVdF: silica (41:37:20:2 mass | | |
| ratio) | | |
| 0.65 M LiPF₆ & 0.75 M M₅IIm in EC:GBL:PVdF | 4.8 | Non-flammable |
| (41:37:22 mass ratio) | | |
| 0.65 M LiPF₆ & 0.75 M Et₄NIm in EC:PC:PVdF | 5.4 | Non-flammable |
| (41:37:22 mass ratio) | | |
| 0.65 M LiPF₆ & 0.75 M M₅IIm in EC:PC:TEGDA | 4.2 | Non-flammable |
| (46:40:14 mass ratio) | | |
| 0.65 M LiPF₆ & 0.75 M M₅IIm in | 5.5 | Non-flammable |
| EC:PC:TEGDA:MMA (46:40:8:6 mass ratio) | | |
| 0.65 M LiPF₆ in EC:PC:PVdF | 4.5 | Flammable |
| (41:37:22 mass ratio) | | |
| 0.65 M LiPF₆ in EC:PC:TEGDA:MMA | 4.1 | Flammable |
| (46:40:8:6 mass ratio) | | |

Ionic Conductivity

GPE disks having a diameter of 1 cm and a uniform thickness of from 200 to 500 μm were cut from a sheet of GPE material and subsequently positioned between stainless steel blocking electrodes with diameters of 1 cm. Ionic conductivities were measured at 25° C. in units of mS/cm by Electrochemical Impedance Spectroscopy in a dry Ar-filled glove box.

As can be seen from the data in Table 1, the measured non-flammable GPE ionic conductivities of from 3-7 mS/cm are adequate for practical discharge rates in a Li-ion battery and are similar to those values for liquid electrolytes.

All GPEs containing EMIIm, BIIm, DMPPF₆, M₅IBeti, M₅PIm, M₅IIm, and Et₄NIm are non-flammable while the GPEs without an ionic liquid material ignited and rapidly burned. This behavior indicates that ionic liquid materials act as effective fire inhibitors/retardants, even when electrolytes comprising the ionic liquid materials are formulated with up to 40 volume percent of highly flammable organic solvents such as PC, EC, and gamma-butyrolactone.

Electrochemical Cycling Experiments

Three different room temperature galvanostatic (constant current) cycling experiments with the non-flammable GPEs were undertaken.

Li/LiₓC half-cells cycled between 1.5 and OV vs. Li/Li⁺

Li/LiCoO₂ full cells cycled between 3.0 and 4.3V vs. Li/Li⁺

LiₓC/LiCoO₂ Li-ion cells cycled between 3.0 to 4.2V, and between 3.0 to 4.6V vs. Li/Li⁺

All cycling experiments employed crimped 2325 coin cells incorporating 1.5 cm diameter GPE disks to assure reproducible results from one type of experiment to another. The cells were assembled in a dry, Ar-filed glove box. The cell anodes were either Li foil disks or commercially available graphite powder on a Cu foil current collector. The cell cathode was LiCoO₂ on an Al foil current collector. Each cycling experiment had a specific purpose: the first, to assess the ability of the GPE to cycle on graphite in a Li/LiₓC half-cell; the second, to assess the ability of the GPE to cycle in a Li metal full cell; and the third, to assess the ability of the GPE to cycle in a Li-ion cell.

Surprisingly, we found that GPEs containing the peralkylated heterocyclic cations such as the M₅I or M₅P cation performed significantly better in cycling experiments, compared to those containing the partially alkylated EMI, or BI, or DMP cations. This may involve the acidic [reactive] nature of certain protons found on the heterocyclic ring systems. Such reactive protons are readily eliminated by replacing the proton(s) with another functional group(s), an alkyl group being one such example.

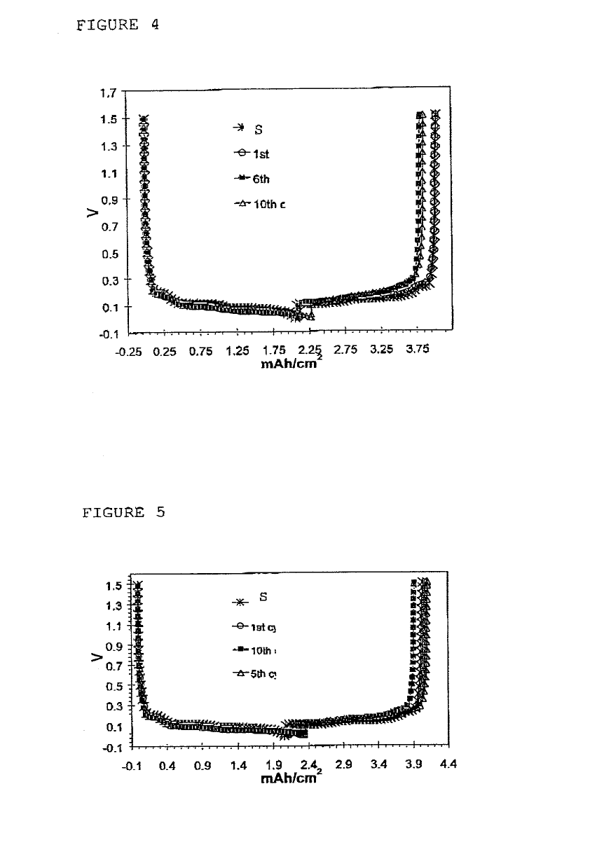

In addition, we found that ionic liquid-based GPEs comprising an organic solvent could be made to cycle at the graphite anode as shown in FIG. 4.

The following examples are presented to illustrate the advantages of the present invention and to assist one of ordinary skill in making and using the same. These examples are not intended in any way otherwise to limit the scope of the disclosure.

Cycling data examples: 2325 coin cells were assembled utilizing LiCoO₂ cathode positive electrodes obtained from working Sony lithium ion batteries and graphite anode negative electrodes. The anodes were made according to the following procedure. In a small container, 0.1 grams of PVDF (KYNAR 761-A) and 0.9 grams of Graphite LVG 2288 (SFG 44) are mixed together. To this mixture, NMP is added dropwise to the container until a slurry is formed. The slurry is cast onto a very thin sheet of copper. The sheet is dried in a vacuum oven at 135° C. for 45 minutes. The vacuum is turned on for 2 hours or more to remove the NMP. The sheet is allowed to cool, and then rolled until the graphite is shiny. The graphite is cut into the proper shape and size, heated overnight at 100° C. to remove last traces of water. Cycling data were typically obtained on a Maccor cycler using a 0.35 mA current between 3.0 and 4.3 volts.

### EXAMPLE 1

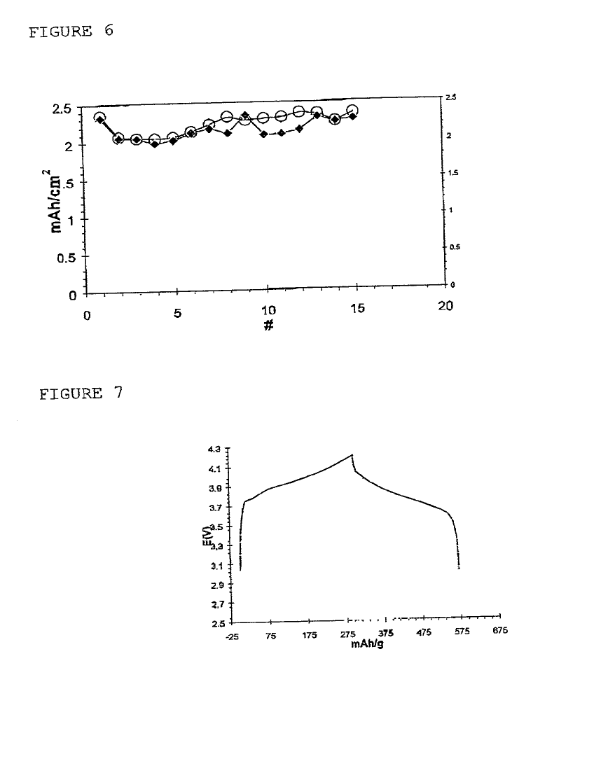

A lithium/graphite half cell was assembled using a graphite electrode that had a preformed SEI. The SEI was formed on the carbon electrode by cycling the graphite for 5 cycles in a 1 M LiPF₆ EC:DMC (1:3) electrolyte. The nonflammable organic salt electrolyte is then swapped for the SEI forming electrolyte. Good intercalation and deintercalation of lithium into the graphite was observed (FIG. 4 and FIG. 5). One can clearly see the three stages of lithium intercalation into the graphite. The cycling dependence of capacity for these two electrolytes is presented in FIG. 6. Comparison to a standard flammable carbonate electrolyte is made.

### EXAMPLE 2

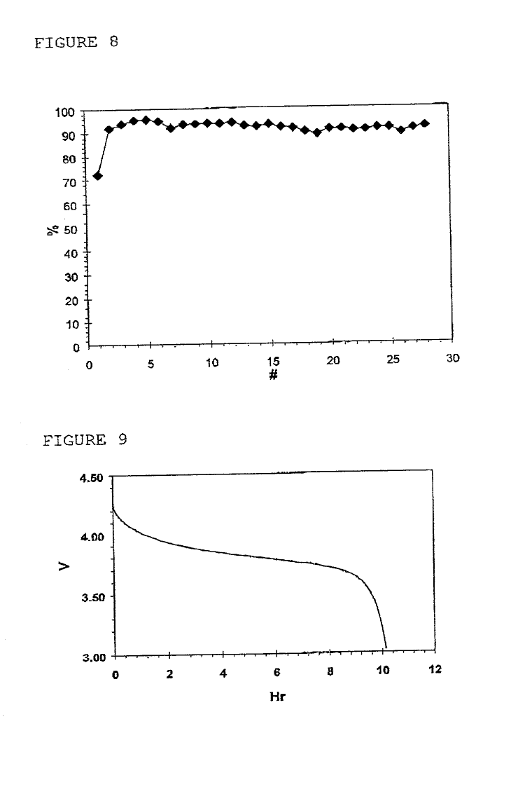

Organic salt electrolytes can be used in lithium ion batteries. A Graphite anode (negative electrode) and LiCoO₂ cathode (positive electrode)battery was assembled using graphite with a preformed SEI as described in Example 1. Good charge and discharge characteristics (FIG. 7) and cycling efficiency is observed (FIG. 8). A capacity of 350 mAhr/g of graphite is possible.

Example 3

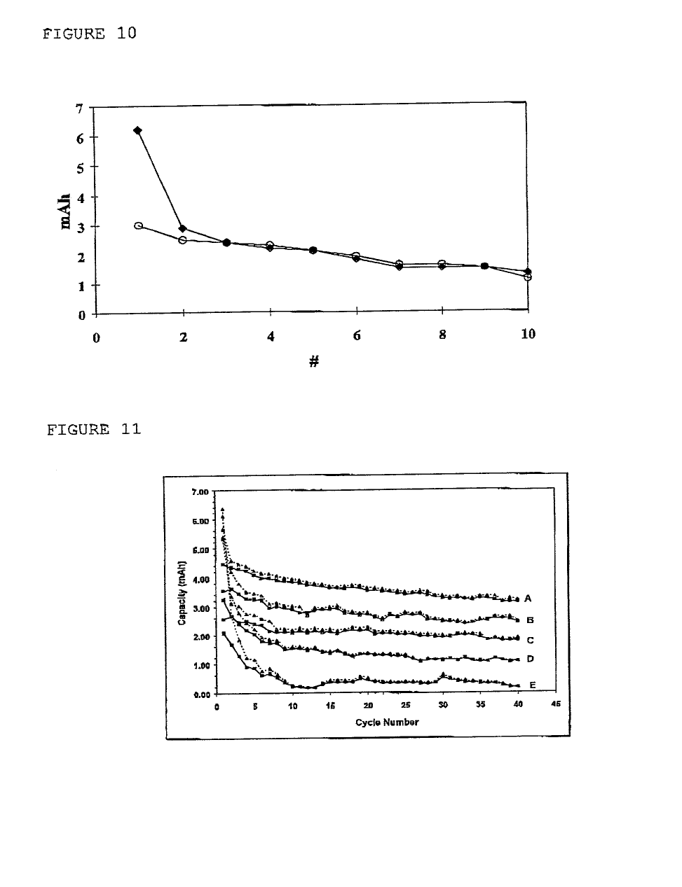

A lithium metal anode and lithiated cobalt oxide cathode battery was assembled with 3M 1,2-dimethyl-3-ethyl imidazolium imide (DMEIIm) in PC as the electrolyte. Surprisingly this battery with no lithium metal salt in the electrolyte showed good discharge characteristics (FIG. 9) and cycling characteristics (FIG. 10).

### EXAMPLE 4

Five lithium ion coin cell batteries were assembled using graphite anode electrodes and LiCoO₂ cathode electrodes and organic salt electrolytes containing glyme, diglyme, triglyme, tetraglyme, or no glyme additive. The batteries containing the glyme and diglyme additives had improved cycling performance (FIG. 11). These organic salt electrolytes form stable SEIs on graphite.

### EXAMPLE 5

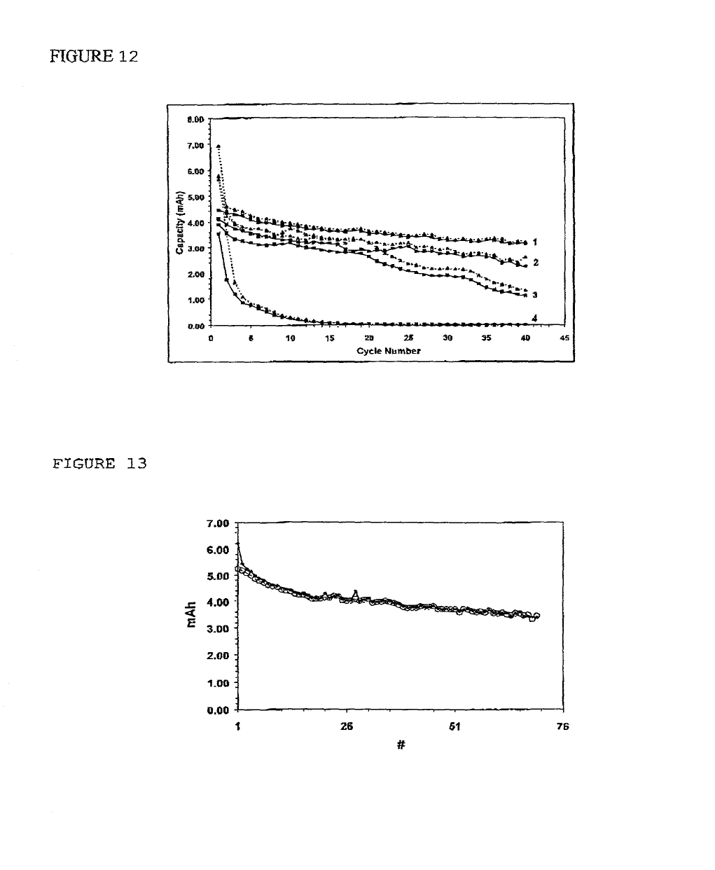

Lithium ion batteries were assembled according to example 4 using organic salt electrolytes containing different lithium salts. We have observed that the capacity and cycle life is best using LiPF₆ in M₅IIm with PC and glyme mixtures (FIG. 12).

### EXAMPLE 6

A lithium ion battery using the nonflammable electrolyte, 0.5 M LiPF₆ and 1.5 M M₅IIm in ethylene carbonate (EC), showed good cycling behavior (FIG. 13) in coin cells using graphite anodes and LiCoO₂ cathodes assembled as described in example 4.

### EXAMPLE 7

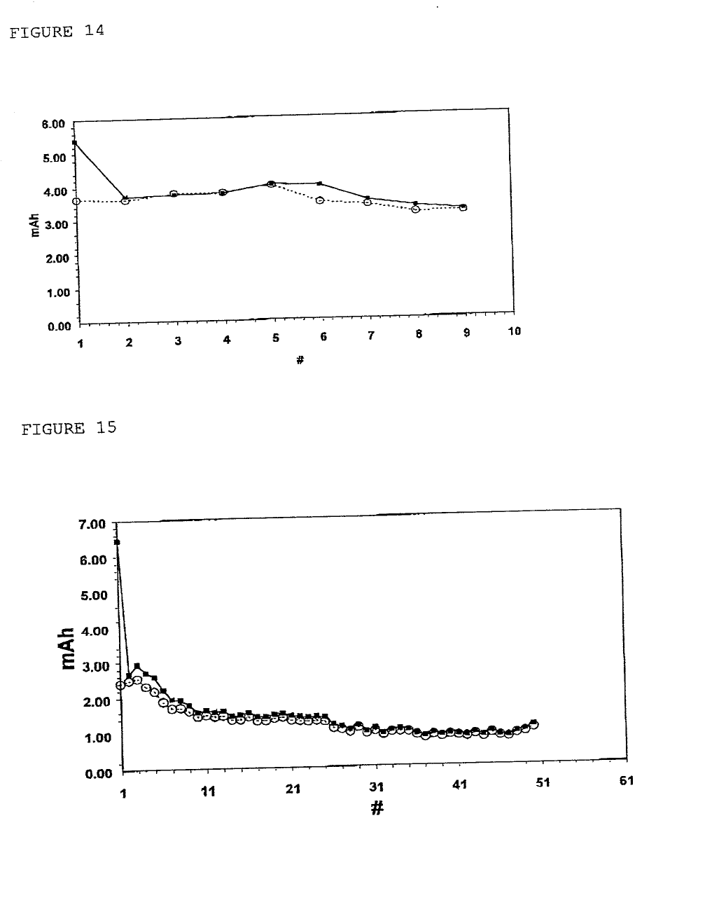

A lithium ion battery using the nonflammable electrolyte, 0.5 M LiPF₆ and 1.5 M TEAIm in ethylene carbonate (EC), showed good cycling behavior (FIG. 14) in coin cells using graphite anodes and LiCoO₂ cathodes assembled as described in example 4.

### EXAMPLE 8

An electrolyte using an organic cation salt with the methide anion shows good cycling behavior (FIG. 15) in a graphite/LiCoO₂ lithium ion battery. The battery was constructed and tested as previously described (example 4) using an electrolyte comprising 0.5 M LiPF₆ and 1.5 M M₅IMe in PC and glyme (1:1 volume ratio).

### EXAMPLE 9

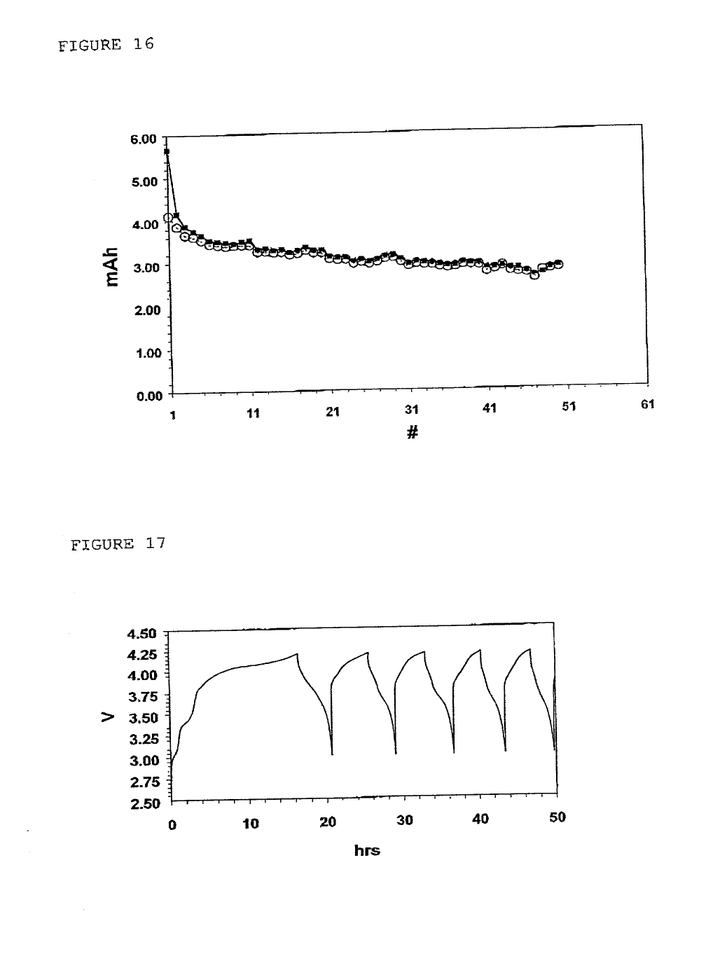

An electrolyte using an organic cation salt with the Beti anion shows good cycling behavior (FIG. 16) in a graphite/LiCoO₂ lithium ion battery. The battery was constructed and tested as previously described (Example 4) using an electrolyte comprising 0.5 M LiPF₆ and 1.5 M M₅IBeti in PC and glyme (1:1 volume ratio).

### EXAMPLE 10

An electrolyte using 1-heptyl-tetramethyl-imidazolium imide (M₄C7IIm) as the organic cation salt shows good cycling behavior (FIG. 17) in a graphite/LiCoO₂ lithium ion battery. The battery was constructed and tested as previously described (example 4) using an electrolyte comprising 0.5 M LiPF6 and 1.5 M M₄C7IIm in PC and glyme (1:1 volume ratio).

### EXAMPLE 11

A clear, colorless solution containing 3.2 g of EC, 2.8 g PC, and 2.2g of BIIm was prepared at room temperature. TEGDA monomer (0.6 g) and MMA monomer (0.4 g) were added such that the resulting solution was approximately 10 volume percent in monomer. Sufficient LiPF₆ was dissolved in the solution to bring the Li⁺ concentration to 0.65M. Finally, a small amount (approximately 0.05M) of a free-radical initiator (either AIBN or BP) was dissolved into the electrolyte. The final composition of the electrolyte was 0.75M BIIm +0.65M LiPF₆/EC:PC:TEGDA:MMA (46:40:8:6 weight percent).

The electrolyte was transferred to a glass or Teflon surface with equipped with either a 200 μm or a 500 μm spacer. The support was covered with either a glass or Teflon sheet and transferred to a 60° C. oven for 30 min. The GPE was then allowed to cure at room temperature for up to 18 hours before subsequent evaluation, the results of which are shown in Table 2.

### EXAMPLE 12

A GPE was produced in the same manner described in Example 11, except that DMPPF₆ was used as the ionic liquid material instead of BIIm. The evaluation results of this GPE are shown in Table 2.

### EXAMPLE 13

A GPE was produced in the same manner described in Example 11, except that M₅IBeti was used as the ionic liquid material instead of BIIm. The evaluation results of this GPE are shown in Table 2.

### EXAMPLE 14

A GPE was produced in the same manner described in Example 11, except that Et₄NIm was used as the ionic liquid material instead of BIIm. The evaluation results of this GPE are shown in Table 2.

### EXAMPLE 15

A GPE was produced in the same manner described in Example 11, except that M₅PIm was used as the ionic liquid material instead of BIIm. The evaluation results of this GPE are shown in Table 2.

### EXAMPLE 16

A GPE was produced in the same manner described in Example 11, except that M₅IIm was used as the ionic liquid material instead of BIIm. The evaluation results of this GPE are shown in Table 2.

### EXAMPLE 17

A GPE was produced in the same manner described in Example 16, except that LiBeti was used as the lithium salt instead of LiPF₆. The evaluation results of this GPE are shown in Table 2.

### EXAMPLE 18

A GPE was produced in the same manner described in Example 11, except that no ionic liquid material was used in the electrolyte formulation. The evaluation results of this GPE are shown in Table 2.

### EXAMPLE 19

A GPE was produced in the same manner described in Example 11, except that no MMA copolymer was used in the electrolyte formulation. The evaluation results of this GPE are shown in Table 2.

### EXAMPLE 20

A GPE was produced in the same manner described in Example 19, except that the electrolyte was subjected to a UV radiation source at room temperature (American Ultraviolet Co.) for 10 min rather than heating the electrolyte in an oven. The evaluation results of this GPE are identical to those for Example 19.

### EXAMPLE 21

A clear, colorless solution containing 3.0 g of EC, 2.7 g of PC, and 2.1 g of M₅IIm was prepared at room temperature. Sufficient LiPF₆ was dissolved in the solution to bring the Li+concentration to 0.65M. PVdF (1.6 g of either Kynar 2801 or 2822) was added with stirring such that the resulting slurry was 22 weight percent in fluorocarbon. The final composition of the electrolyte was 0.75M M₅IIm+0.65M LiPF₆/EC:PC:PVdF (41:37:22 weight percent).

The slurry was transferred to a glass or Teflon surface with equipped with either a 200 μm or a 500 μm spacer. The support was covered with either a glass or Teflon sheet and transferred to an oven at a temperature of from 100 to 115° C. for 10 min. The GPE was then allowed to cool to room temperature before subsequent evaluation, the results of which are shown in Table 2.

### EXAMPLE 22

A GPE was produced in the same manner described in Example 21, except that 2 weight percent fumed silica dioxide (Degussa Aerosil® 200) was added to the electrolyte formulation. The evaluation results of this GPE are shown in Table 2.

### EXAMPLE 23

A GPE was produced in the same manner described in Example 21, except that GBL solvent was used in place of PC in the electrolyte formulation. The evaluation results of this GPE are shown in Table 2.

### EXAMPLE 24

A GPE was produced in the same manner described in Example 11, except that Et₄NIm was used as the organic cation salt in the electrolyte formulation. The evaluation results of this GPE are shown in Table 2.

### EXAMPLE 25

A GPE was produced in the same manner described in Example 21, except that, according to prior art technology no organic cation salt material was used in the electrolyte formulation. The evaluation results of this GPE are shown in Table 2. As can be seen, a GPE with no organic cation salt is flammable.

### EXAMPLE 26

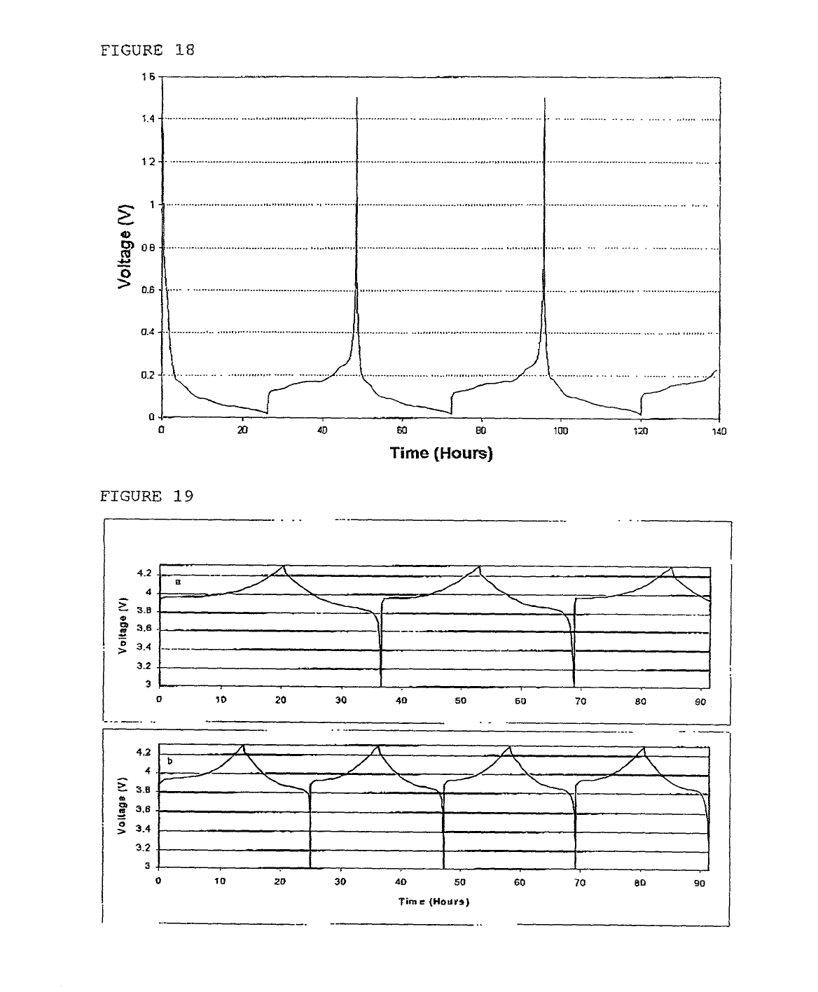

Li-intercalation voltage profiles and cycling capacities achieved with either the LiPF₆/M₅IIm:EC:PC:PVdF hot melt electrolyte or the LiPF₆/M₅IIm:EC: PC:TEG-DA thermally polymerized electrolyte are similar in providing close to the theoretical Li⁺ intercalation capacity of graphite (FIG. 18).

FIG. 19 shows the voltage profile of a LiPF₆/M5IIm:EC:PC:PVdF electrolyte in a Li/LiCoO₂ coin cell to a cutoff voltage of 4.3 V at two different temperatures, i.e., at 25° C. [FIG. 19a] and at 37° C. (FIG. 19b). In both cases the charge and discharge curves are well behaved and we achieved a LiCoO₂ cathode capacity close to the theoretical value at the 4.3V cutoff potential.

### EXAMPLE 27

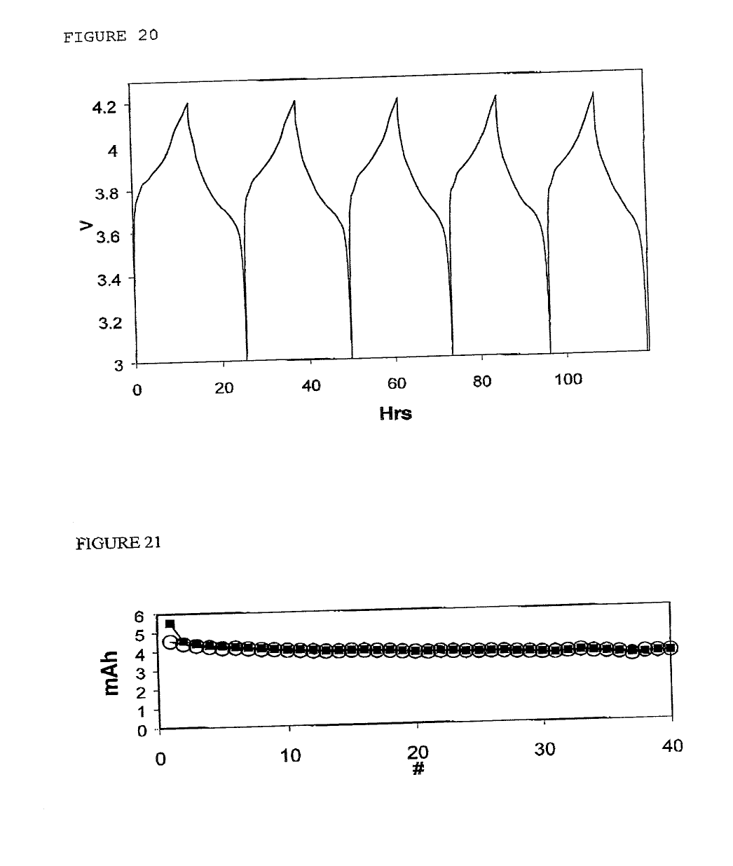

Several Li-ion coin cells cycling studies comprising either a thermally polymerized LiPF₆/M₅IIm:EC:PC:TEG-DA electrolyte or a LiPF₆/M₅IIm:EC:PC:PVdF electrolyte sandwiched between a LiₓC graphite anode and a LiCoO₂ cathode were conducted. The room temperature voltage profile is shown in FIG. 20 where good charge/discharge behavior was observed.

### EXAMPLE 28

FIG. 21 plots capacity against cycle life for a Li-ion coin cell containing a LiPF₆/M₅IIm:EC:PC:PVdF GPE to a 4.2V cutoff potential at room temperature.

### EXAMPLE 29

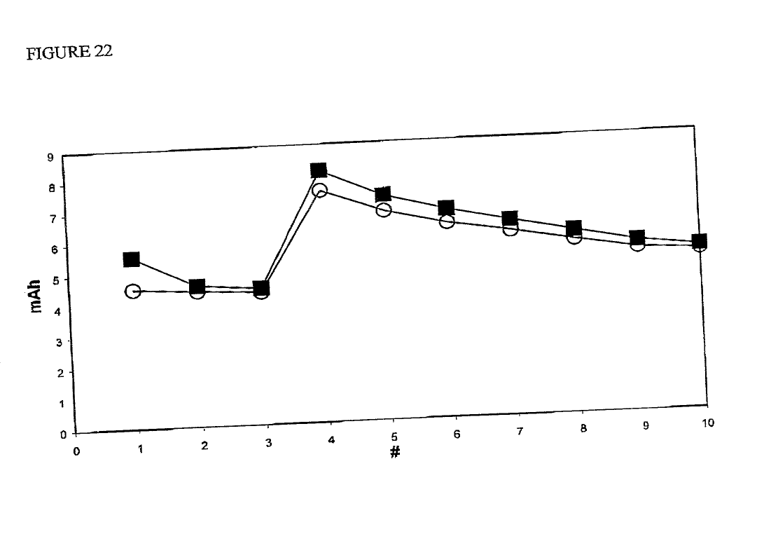

The ability to cycle GPEs to high voltage cutoff potentials in Li-ion coin cells was also evaluated. By raising the cell cutoff voltage on charge, the greater the energy that can be extracted from the cell. FIG. 22 shows a plot of capacity versus cycle life at two different cutoff potentials: 4.2 V vs. Li/Li⁺, which is the industry standard, and 4.6 V vs. Li/Li⁺ for a LiₓC/LiCoO₂ coin cell containing LiPF₆/M₅IIm:EC:PC:PVdF. After the first three cycles to the 4.2 V cutoff the potential was raised to 4.6 V. At the tenth cycle an additional 25% in cell capacity was obtained.

### EXAMPLE 30

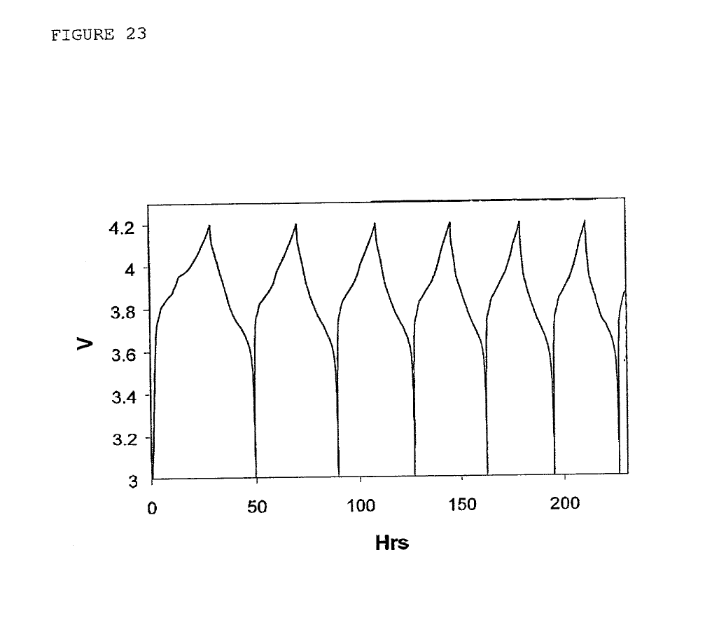

The GPE electrolyte of example 24 was used to assemble a LiₓC/LiCoO₂ battery. The cycling data is shown in FIG. 23.

### EXAMPLE 31

The following organic cation salts have been found not to perform well in lithium ion coin cells (assembled as in Example 4) due to poor cycling. These are part of the group of organic cation salts that need to have a preformed SEI prepared first on the carbon anode (as in Example 1) or to have additives to make the SEI.

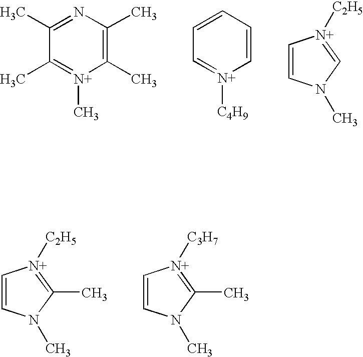

The flammability of the liquid electrolytes was determined by immersing a fiberglass wick (from fiberglass cloth insulation) in the sample electrolyte and then suspending this doused wick on a wire gauze. One end of the wick is engulfed in flames from a butane torch. The torch is removed and the time it takes the flame to propagate 10 cm is measured. As shown in Table 3 the addition of organic cation salts decreases the flammability of the electrolytes.

TABLE 3
Burn rate of solvents, typical electrolytes, and
electrolytes of this invention.

| | Burn rate |
|---|---|
| Sample | (mm/min) |
| Acetone | 6250 |
| PC:EC (1:1 volume ratio) | 85 |
| EMIImide | Does not burn |
| M₅IImide | Does not burn |
| M₅IImide(67%)/PC:EC(1:1) (38%) | Does not burn |
| 0.5 M LiPF₆/PC:EC (1:1) | 150 |
| 0.5 N LiPF₆/EMIImide | Does not burn |
| 0.5 M | 120 |
| LiPF₆/EMIImide(50%), PC:EC(1:1) (50%) | |
| 0.5 M LiPF₆ & 1.5 M M₅IBeti/EC | Does not burn |
| 0.6 M LiPF₆ & 0.75 M M₅IBeti/PC:EC | Does not burn |
| (1:1) | |

### EXAMPLE 33

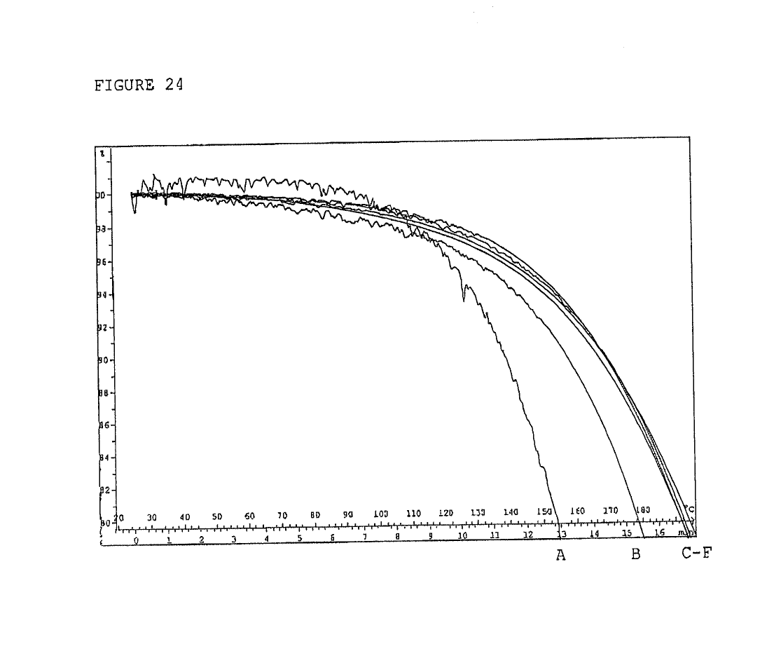

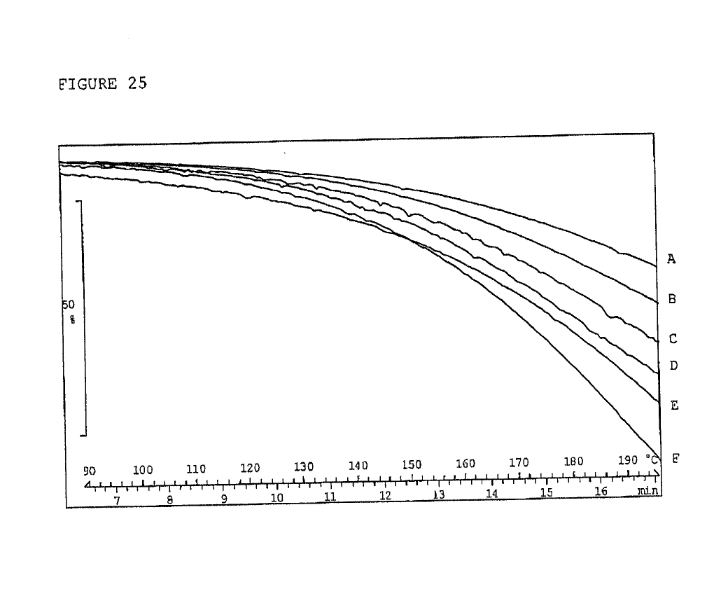

The decrease in volatility for the organic cation salt containing liquid electrolytes, compared to a standard electrolyte (0.5 M LiPF₆/EC) can be observed in the Thermal Gravimetric Analysis (TGA) results depicted in FIG. 24. The shift to higher temperatures for the observed weight loss is an indication of the decreased volatility for the organic cation salt containing electrolytes.

### EXAMPLE 34

The decrease in volatility for the organic cation salt containing gel polymer electrolytes, compared to a GPE not containing these organic cation salts can be observed in the Thermal Gravimetric Analysis (TGA) results depicted in FIG. 25. The shift to higher temperatures for the observed weight loss is an indication of the decreased volatility for the organic cation salt containing electrolytes.

While the present invention has been described in conjunction with a preferred embodiment, one of ordinary skill, after reading the foregoing specification, will be able to effect various changes, substitutions of equivalents, and other alterations to the compositions and methods set forth herein. It is therefore intended that the protection granted by Letters Patent hereon be limited only by the definitions contained in the appended claims and equivalents thereof.

What is claimed is:

1. A method of forming a lithium ion battery having reduced flammability, said method comprising the steps of:
assembling a battery skeleton comprising a carbon anode electrode, a cathode electrode, a separator and packaging for said battery;
forming a solid electrolyte interphase on said carbon anode using a first electrolyte;
combining a lithium metal salt and an organic solvent and mixing with said combination an organic cation salt to form an organic cation salt electrolyte, wherein said cation in said salt is selected from the group consisting of: 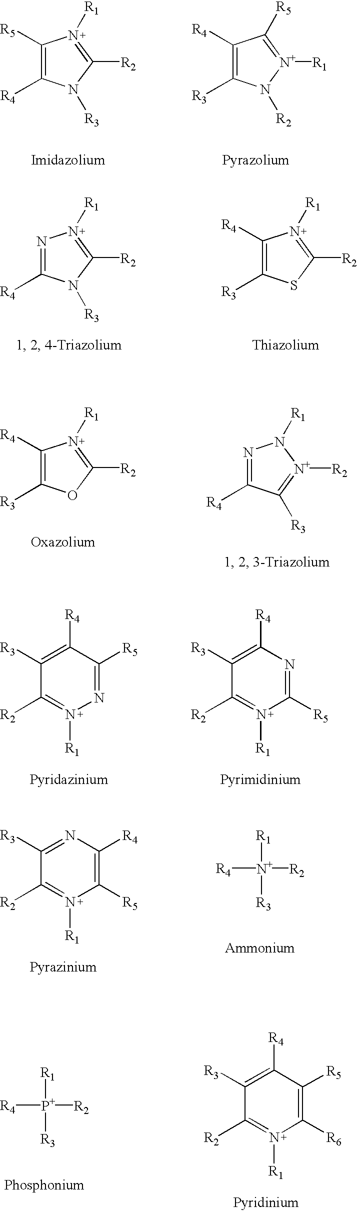
wherein R₁, R₂, R₃, R₄, R₅, and R₆ are either H; or F; or separate alkyl groups of from 1 to 15 carbon atoms, respectively; or 5 two of said separate alkyl groups are joined together to constitute a unitary alkylene radical of from 2 to 6 carbon atoms forming a ring structure converging on N; or separate phenyl groups, and
wherein said alkyl groups, said unitary alkylene radical or said phenyl groups are optionally substituted;
replacing said first electrolyte with said organic cation salt electrolyte; and
sealing said battery.

2. A lithium ion battery made by the method of claim 1.

3. The method of claim 1, wherein, in said combining step, said cation in said organic cation salt is 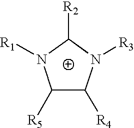
wherein R₄ and R₅ are not equal to H.

4. The method of claim 1, wherein, in said combining step, said organic cation salt is added at a concentration of greater than 0.5 M.

5. The method of claim 1, wherein, in said combining step, said organic cation salt is added at a concentration of greater than 1 M.

6. The method of claim 1, wherein, in said combining step, said organic solvent is selected from the group consisting of organic carbonates, gamma-butyrolactone, methyl acetate, ethyl acetate, methyl formate, sulfolane, methylsulfolane, diethyl ether, methyl ethyl ether, tetrahydrofuran, 2-methyltetrahydrofuran, 1,3-dioxolane, nitromethane, acetonitrile, dimethylformamide, dimethylacetamide, dimethylsulfoxide, benzonitrile and combinations thereof.

7. The method of claim 1, wherein, in said combining step, said carbonate solvent is selected from the group consisting of ethylene carbonate, propylene carbonate, butylene carbonate, dimethyl carbonate, diethyl carbonate, ethyl methyl carbonate, ethyl propyl catbonate, propyl methyl carbonate, butyl methyl carbonate, vinylene carbonate and combinations thereof.

8. The method of claim 1, further comprising the step of increasing the viscosity of said organic cation salt electrolyte in said battery with the addition of a binder.

9. The method of claim 1, wherein, in said combining step, an additive selected from the group consisting of vinylene carbonate, an alkyl phosphonate and an alkyl nitrite, all at a concentration less than 0.5 M, is further included in said mixture.

10. An electrolyte having reduced flammability, said electrolyte comprising:
an organic cation salt, wherein said cation in said salt is selected from the group consisting of: 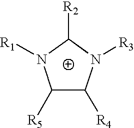
wherein R₁, R₂, R₃, R₄, and R₅ are not equal to H 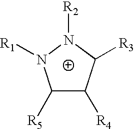
wherein R₁ and R₂ are not equal to H, and 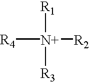
wherein R₁, R₂, R₃, and R₄ are not equal to H;
an organic solvent; and
a metal salt comprising an alkali or alkaline earth metal cation.

11. An electrolyte having reduced flammability, said electrolyte comprising:
an organic cation salt, wherein said cation in said salt is: 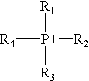
wherein R₁, R₂, R₃, and R₄ are not equal to H;
an organic solvent; and
a metal salt comprising an alkali or alkaline earth metal cation.

12. The electrolyte of claim 10 or claim 11, wherein said cation in said metal salt is selected from the group consisting of Li⁺, Na⁺, K⁺, Mg⁺⁺, Ca⁺⁺, Al⁺⁺⁺ and combinations thereof.

13. An electrochemical cell comprising
an anode;
a cathode; and
the electrolyte of claim 10 or claim 11.

14. A battery comprising the electrochemical cell of claim 13.

15. The electrolyte of claim 10 or claim 11 wherein said organic solvent is selected from the group consisting of organic carbonates, gamma-butyrolactone, methyl acetate, ethyl acetate, methyl formate, sulfolane, methylsulfolane, diethyl ether, methyl ethyl ether, tetrahydrofuran, 2-methyltetrahydrofuran, 1,3-dioxolane, nitromethane, acetonitrile, dimethylformamide, dimethylacetamide, dimethylsulfoxide, benzonitrile and combinations thereof.

16. The electrolyte of claim 10 or claim 11 wherein said carbonate solvent is selected from the group consisting of ethylene carbonate, propylene carbonate, butylene carbonate, dimethyl carbonate, diethyl carbonate, ethyl methyl carbonate, ethyl propyl catbonate, propyl methyl carbonate, butyl methyl carbonate, vinylene carbonate and combinations thereof.

17. An electrolyte having reduced flammability, said electrolyte comprising:
an organic cation salt at a concentration of greater than or equal to 0.75 M, wherein said cation in said salt is selected from the group consisting of: 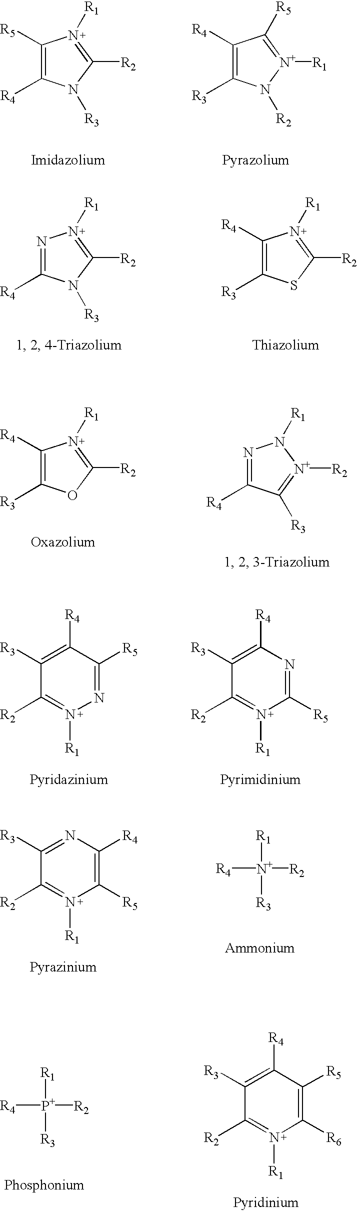
wherein R₁, R₂, R₃, R₄, R₅, and R₆ are either H; or F; or separate alkyl groups of from 1 to 15 carbon atoms, respectively; or two of said separate alkyl groups are joined together to constitute a unitary alkylene radical of from 2 to 6 carbon atoms forming a ring structure converging on N; or separate phenyl groups, and
wherein said alkyl groups, said unitary alkylene radical or said phenyl groups are optionally substituted;
an organic solvent; and
a metal salt comprising an alkali or alkaline earth metal cation.

18. The electrolyte of claim 17 wherein said cation in said metal salt is selected from the group consisting of Li⁺, Na⁺, K⁺, Mg⁺⁺, Ca⁺⁺, Al⁺⁺⁺ and combinations thereof.

19. An electrochemical cell comprising
an anode;
a cathode; and
the electrolyte of claim 17.

20. A battery comprising the electrochemical cell of claim 19.

21. The electrolyte of claim 17, wherein said organic solvent is selected from the group consisting of organic carbonates, gamma-butyrolactone, methyl acetate, ethyl acetate, methyl formate, sulfolane, methylsulfolane, diethyl ether, methyl ethyl ether, tetrahydrofuran, 2-methyltetrahydrofuran, 1,3-dioxolane, nitromethane, acetonitrile, dimethylformamide, dimethylacetamide, dimethylsulfoxide, benzonitrile and combinations thereof.

22. The electrolyte of claim 17 wherein said carbonate solvent is selected from the group consisting of ethylene carbonate, propylene carbonate, butylene carbonate, dimethyl carbonate, diethyl carbonate, ethyl methyl carbonate, ethyl propyl catbonate, propyl methyl carbonate, butyl methyl carbonate, vinylene carbonate and combinations thereof.

23. The electrolyte of anyone of claims 10, 11 or 17, wherein the viscosity of said electrolyte is increased with the addition of a binder.

24. The electrolyte of anyone of claims 10, 11 or 17, further comprising an additive selected from the group consisting of vinylene carbonate, an alkyl phosphonate and an alkyl nitrite, having a concentration less than 0.5 M.

25. A gel polymer electrolyte having reduced flammability, said gel polymer electrolyte comprising:
an organic cation salt, wherein said cation in said salt is selected from the group consisting of: 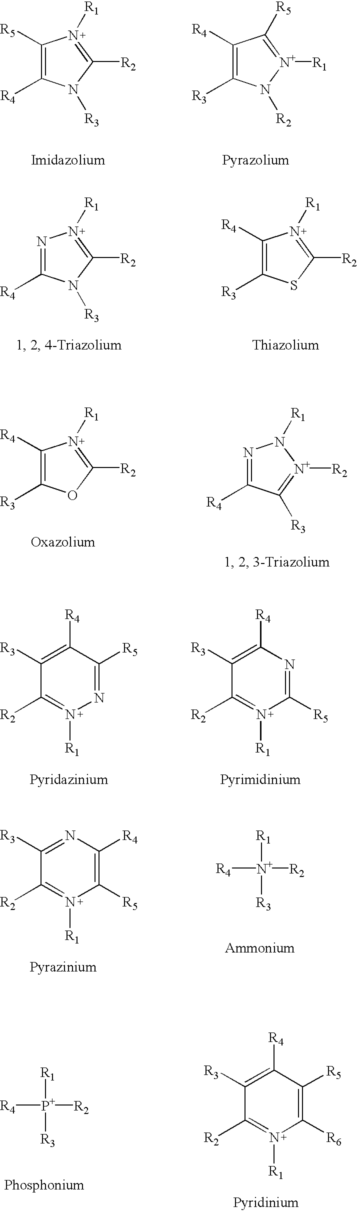
wherein R₁, R₂, R₃, R₄, R₅, and R₆ are either H; or F; or separate alkyl groups of from 1 to 15 carbon atoms, respectively; or two of said separate alkyl groups are joined together to constitute a unitary alkylene radical of from 2 to 6 carbon atoms forming a ring structure converging on N; or separate phenyl groups, and wherein said alkyl groups, said unitary alkylene radical or said phenyl groups are optionally substituted;
an organic solvent;
a metal salt comprising an alkali or alkaline earth metal cation; and
one or more polymers selected from the group consisting of acrylate polymer and fluoropolymer.

26. The gel polymer electrolyte of claim 25, wherein said acrylate polymer is a methacrylate polymer with at least 1 monomer copolymerizable to methylmethacrylate.

27. The gel polymer electrolyte of claim 25, wherein said one or more polymers consist of a mixture of two or more polymers.

28. The gel polymer electrolyte of claim 25, wherein said fluoropolymer is poly(vinylene)fluoride.

29. The gel polymer electrolyte of claim 26, wherein said monomer is selected from the group consisting of styrene-containing monomers, cyano-group-containing monomers, unsaturated carboxylic acids, acid anhydrides, esters, vinyl halides, vinylene halide monomers, vinyl esters, vinyl ethers and dienes.

30. The gel polymer electrolyte of claim 29, wherein said monomer is selected from the group consisting of styrene, divinylbenzene, methacrylonitrile, acrylic acid, sodium acrylate, maleic anhydride, methyl methacrylate, ethyl acrylate, propyl acrylate, tetra(ethylene glycol) diacrylate, hydroxyethyl methacrylate, vinyl chloride, vinyl fluoride, vinyl bromide, vinylene chloride, vinylene fluoride, vinylene bromide, vinyl formate, vinyl acetate, vinyl group-containing acids compounds or their salts, anhydrides or derivatives, methyl vinyl ether, butadiene, isoprene and chloroprene.

31. The gel polymer electrolyte of claim 25, wherein said solvent is selected from the group consisting of organic carbonates, gamma-butyrolactone, methyl acetate, ethyl acetate, methyl formate, sulfolane, methylsulfolane, diethyl ether, methyl ethyl ether, tetrahydrofuran, 2-methyltetrahydrofuran, 1,3-dioxolane, nitromethane, acetonitrile, dimethylformamide, dimethylacetamide, dimethylsulfoxide, benzonitrile and combinations thereof.

32. The gel polymer electrolyte of claim 31, wherein said organic carbonate is selected from the group consisting of ethylene carbonate, propylene carbonate, butylene carbonate, dimethyl carbonate, diethyl carbonate, ethyl methyl carbonate, ethyl propyl catbonate, propyl methyl carbonate, butyl methyl carbonate, vinylene carbonate and combinations thereof.

33. The gel polymer electrolyte of claim 25, wherein said cation in said metal salt is selected from the group consisting of Li⁺, Na⁺, K⁺, Mg⁺⁺, Ca⁺⁺, Al⁺⁺⁺ and combinations thereof.

34. The gel polymer electrolyte of claim 25, wherein said anion in said metal salt is selected from the group consisting of I⁻, Br⁻, SCN⁻, BF₄⁻, PF₆⁻, AsF₆⁻, CF₃SO₂⁻, (CF₃SO₂)₂N⁻, (CF₃CF₂SO₂)₂N^{-, and (CF}₃SO₂)₃C⁻.

35. The gel polymer electrolyte of claim 25 further comprising a saturated or unsaturated cyclic or acyclic organic carbonate or lactone.

36. The gel polymer electrolyte of claim 25 further comprising an additive selected from the group consisting of vinylene carbonate, an alkyl phosphonate and an alkyl nitrite, having a concentration less than 0.5 M.

37. The gel polymer electrolyte of claim 25 wherein said organic cation salt is an peralkylated imidazolium cation in combination with various anions.

38. A method for the production of a gel polymer electrolyte comprising the steps of:
combining to form a mixture an organic solvent, one or more polymers selected from the group consisting of acrylate polymers and fluoropolymers, a metal salt comprising an alkali or alkaline earth metal cation, and an organic cation salt, wherein said cation in said salt is selected from the group consisting of: 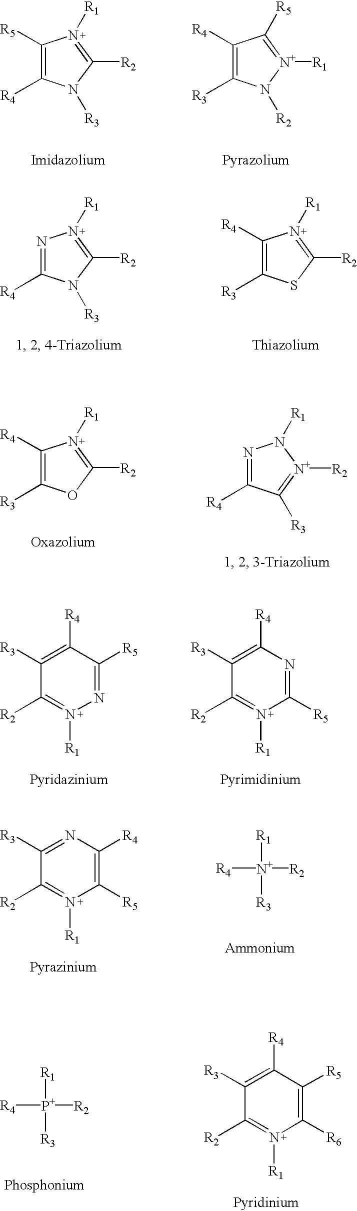
wherein R₁, R₂, R₃, R₄, R₅, and R₆ are either H; or F; or separate alkyl groups of from 1 to 15 carbon atoms, respectively; or two of said separate alkyl groups are joined together to constitute a unitary alkylene radical of from 2 to 6 carbon atoms forming a ring structure converging on N; or separate phenyl groups, and
wherein said alkyl groups, said unitary alkylene radical or said phenyl groups are optionally substituted; and
processing said mixture.

39. The method of claim 38, wherein said processing step is selected from the group consisting of:
a. heating said mixture at approximately 100° C. to yield a homogeneous melt, followed by casting and cooling said melt,
b. exposing said mixture to UV-light initiated polymerization, said mixture also containing a photoinitiator, and
c. exposing said mixture to thermal initiated polymerization at approximately 60° C.
